(19) United States
(12) Patent Application Publication
(10) Pub. No.: US 2006/0038999 A1
(43) Pub. Date: Feb. 23, 2006

(54) Polarization conversion unit for reducing polarization dependent measurement errors

(76) Inventors: Christian Hentschel, Gaufelden (DE); Peter Thoma, Rottenberg (DE)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/532,776

(22) PCT Filed: Oct. 25, 2002
(86) PCT No.: PCT/EP02/11932

§ 371 Date: Apr. 22, 2005

(51) Int. Cl. G01J 4/00

(52) U.S. Cl. 356/364

(57) ABSTRACT

A first optical signal with a first polarization state is received by a polarization conversion unit. From this first optical signal, a set of n derived optical signals with n different well-defined polarization states i, i=1, . . . , n, is generated, whereby n is a natural number greater than one. Said n different well-defined polarization states are chosen such that polarization dependent measurement errors of the n derived optical signals cancel each other when averaged irrespective of the first optical signal's polarization state. Therefore, polarization dependent measurement errors can be reduced or even eliminated.

### BACKGROUND OF THE INVENTION

The present invention relates to reducing or eliminating polarization dependent measurement errors.

Different techniques for depolarizing an optical signal have been described:

In the article “Performance of Lyot Depolarizers with Birefringent Single-Mode Fibers” by K. Böhm and K. Petermann, Journal of Lightwave Technology, vol. LT-1, No. 1, March 1983, pp-71-74, a fiber-optic depolarizer is described that may be realized by using a birefringent fiber. The birefringent fiber is cut and then spliced again, after turning one end by an angle of 45°. Different spectral components of polarized input light are converted to different polarization states at the output, so that the output light appears unpolarized if averaged over the spectrum.

In the product note 11896-2 “Polarization-dependent loss measurements using modular test system configurations” of Agilent Technologies, http://www.agilent.com/cm/rdmfg/appnotes/polarizationanalysis_an.shtml, it is described how the polarization dependent loss (PDL) of a device under test can be measured using an Agilent 11896A polarization controller. The Agilent 11896A polarization controller comprises an internal four-fiber-loop assembly. Complete and continuous polarization adjustability is achieved by independently rotating each loop over a 180° angular range. From FIG. 3 of the document, it can be seen that the entire Poincaré sphere is covered in a pseudo-random manner.

### SUMMARY OF THE INVENTION

It is an object of the invention to improve reducing of polarization dependent measurement errors. The object is solved by the independent claims. Preferred embodiments are shown by the dependent claims.

According to the present invention, a polarization conversion unit is provided which converts a first optical signal with an arbitrary first polarization state into a set of derived optical signals. The set of derived optical signals comprises n optical signals with n different well-defined polarization states, whereby n is a natural number greater than one. For each of said n derived optical signals, a measurement of an optical property is performed. Said optical property might for example be the derived optical signal's signal strength, but the invention is also applicable to measurements of any other optical property. The relationship between the n polarization states of the derived optical signals and the first polarization state of the first optical signal is chosen in a way that the polarization dependent measurement errors obtained for the n different well-defined polarization states cancel irrespective of the first optical signal's polarization state.

For each one of the derived optical signals i, i=1, . . . n, a polarization dependent measurement error E_{PDL}(i) is caused by the components of the receiver circuitry. The idea is to generate the derived optical signals in a way that the corresponding errors E_{PDL}(i) of the measurement results obtained for the various polarization states of the derived optical signals cancel when the measurement results obtained for the n derived optical signals are summed up, or when a mean value of these results is determined. Though the measurement error E_{PDL}(i) for each single measurement might still be of considerable magnitude, these errors cancel during the averaging procedure.

According to the invention, the strategy is to place said n well-defined polarization states such that the measurement errors compensate each other. The polarization conversion unit therefore acts as a depolarizer that is suitable for reducing or eliminating polarization dependent error.

The total polarization dependent measurement error of the averaged or summed up result is considerably reduced or eliminated, and the accuracy of the averaged or summed up result is improved. For example, when the polarisation conversion unit is used in a PDL measurement set-up, an improvement of the PDL measurement uncertainty in the order of 10 in comparison to a non-depolarized set-up can be expected. It has to be pointed out that the invention is in no way limited to power measurements or loss measurements. The polarization conversion unit according to the invention can be used whenever an optical property has to be determined that is impaired by any kind of polarization dependent measurement error.

Another advantage is that the polarization conversion unit can be implemented in a way that its insertion loss is rather small or even negligible. The polarization conversion unit will not significantly impair the intensity of the first optical signal, and therefore, the full dynamic range of said signal is maintained.

When birefringent fibers are used for depolarizing an optical signal, the signal's different spectral components are converted into different polarization states at the fiber's output. For this reason, depolarization of an optical signal by means of birefringent fibers works only if the spectral width of the light source is sufficiently large, typically in the order of nanometers. Tunable laser sources have a rather narrow spectral width in the order of picometers, and therefore, depolarizers based on birefringent fibers are not applicable. The polarization conversion unit according to the present invention is capable of reducing or eliminating polarization dependent measurement errors even in case the spectral width of the respective laser source is extremely narrow. For this reason, the invention can be applied for depolarizing light generated by a tunable laser source. The polarization conversion unit according to the invention is even suitable for single wavelength operation.

When the n derived polarization states of the n optical signals are chosen according to the invention, the number of measurements that have to be performed in order to eliminate polarization dependent errors is much smaller than in depolarizing techniques of the prior art. Especially for random or pseudo random scrambling techniques, a good coverage of the Poincaré sphere requires to perform a large number of measurements, typically more than 30 measurement points per wavelength. According to the invention, only n measurements per wavelength are required. Therefore, the total measurement time is significantly reduced.

According to a preferred embodiment, the number n of derived optical signals is smaller than ten. When the polarization states are chosen according to the present invention, a small number of n measurements performed for n different polarization states is sufficient for eliminating the polarization dependent measurement error. As will be shown below, by performing measurements for as few as two or four different polarization states, it is possible to eliminate the polarization dependent measurement error. The total measurement time is significantly reduced. Optical measurements where wavelength sweeps have to be performed can be carried out in a short period of time.

According to the preferred embodiment, the derived polarization states are generated by applying a sequence of predetermined conversion steps to the first optical signal's polarization state. By consecutively subjecting the first polarization state to a number of predetermined optical transformations, the n derived polarization states are generated. For each of the n derived polarization states, there exists a well-defined relationship to the first optical signal's polarization state.

According to another preferred embodiment of the invention, when the signal strength of an optical signal is measured, e.g. the PDL of the receiver circuitry might cause a polarization dependent measurement error. Said error can be described in terms of the incident's signal's polarization state relative to the principal states of polarization of the receiver circuitry. When S denotes the polarization state of the incident optical signal, and when Sₘᵢₙ and Sₘₐₓ denote the receiver circuit's principal states of polarization, then the polarization dependent measurement error E_{PDL}(S) can be written as E_{PDL}=ΔA·cos δ, whereby δ is the angle between S and Sₘₐₓ. In order to achieve that the polarization dependent measurement errors obtained for the n derived polarization states cancel irrespective of the first optical signal's polarization state, the polarization states of the n derived optical signals can be chosen such that

$${\sum }_{i = 1}^{n} cos {δ}_{i} = 0.$$

This simple criterion allows to arrive at a suitable set of polarization states. The advantage is that instead of covering the entire Poincaré sphere in a pseudo-random manner, only a small number of n measurements has to be performed.

According to a first embodiment of the invention, two optical signals S and S* are derived from said first optical signal's polarization state, whereby S* is the inverse polarization state of the polarization state S. Irrespective of the first optical signal's state of polarization, the polarization dependent errors E_{PDL}(S) and E_{PDL}(S*) cancel to zero. By averaging over the optical powers of the input polarization state and of its inverse state, it is possible to eliminate the total measurement error of the averaged power.

According to a second embodiment of the invention, four polarization states S_{A}, S_{B}, S_{C}, S_{D} are generated from said first polarization state by means of a planar rotator, preferably a Faraday rotator, and a rotatable quarter wave plate. The angle of rotation of a Faraday rotator can e.g. be varied by changing a magnetic field applied in the direction of light propagation. One advantage of this embodiment is that the rotator itself is not rotated and does not comprise any movable parts, which would limit the scan speed. The measurement process is accelerated. Another advantage is that the angle of rotation does not vary with the wavelength of the incident light. When performing a wavelength sweep, the angle of rotation remains constant, and there are no chromatic variations that would degrade the obtained polarization states. A further advantage of this embodiment is that both the rotator and the quarter wave plate exhibit negligible loss. Therefore, the full dynamic range of the first optical signal is maintained.

According to a third embodiment of the invention, the four polarization states S_{A}, S_{B}, S_{C}, S_{D} are generated from said first optical signal's polarization state by means of a rotatable half wave plate and a rotatable quarter wave plate. Also in this embodiment, the insertion loss of the polarization conversion unit is negligible. In case single wavelength measurements are performed, or in case the wavelength is swept over a small wavelength range, the measurement accuracy achieved with conventional quarter wave plates and half wave plates is usually sufficient. In case wavelength sweeps covering a large range of wavelengths are performed, achromatic quarter and half wave plates might be used. This allows generating polarization states of high accuracy over a large range of wavelengths.

The invention can be partly or entirely embodied or supported by one or more suitable software programs, which can be stored on or otherwise provided by any kind of data carrier, and which might be executed in or by any suitable data processing system. Software programs or routines are preferably applied for controlling at least one of the rotation angle of the Faraday rotator, the angular position of the quarter wave plate, the angular position of the half wave plate, the data acquisition and the averaging process.

### BRIEF DESCRIPTION OF THE DRAWINGS

Other objects and many of the attendant advantages of the present invention will be readily appreciated and become better understood by reference to the following detailed description when considering in connection with the accompanied drawings. Features that are substantially or functionally equal or similar will be referred to with the same reference sign(s).

FIG. 1 shows a measurement set-up for determining the PDL of a DUT;

FIG. 2 depicts the polarization state S of the DUT output signal, together with the polarization states of maximum and minimum transmission of the measurement system's receiver circuitry,

FIG. 3 shows a measurement set-up for loss measurements comprising a polarization conversion unit and an averaging unit;

FIG. 4 shows an embodiment of a polarization conversion unit comprising a planar rotator and a rotatable quarter wave plate;

FIG. 5 depicts the input polarization state Sᵢₙ together with the four derived polarization states S_{A}, S_{B}, S_{C}, S_{D}; and

FIG. 6 shows an embodiment of the polarization conversion unit comprising a rotatable half wave plate and quarter wave plate.

### DETAILED DESCRIPTION OF EMBODIMENTS OF THE INVENTION

In FIG. 1, a measurement set-up for determining the polarization dependent loss (PDL) of a device under test is shown. A laser source 1 generates a ray of light 2 of a defined wavelength. The laser source 1 can be a tunable laser source adapted for performing wavelength sweeps, whereby the wavelength of the light 2 is varied over a certain range of wavelengths. Alternatively, the laser source 1 might generate light of a fixed wavelength. The light 2 is forwarded to a polarization controller 3, which can be used to set the polarization of the light 2 to any desired state of polarization. The polarized light 4 obtained at the output of the polarization controller 3 is incident upon a device under test 5. At the output of the device under test 5, a DUT output signal 6 is obtained. In order to determine the polarization dependent loss of the device under test 5, the signal strength of the DUT output signal 6 has to be measured, as a function of wavelength, for different settings of the polarization controller 3. For this purpose, the measurement set-up comprises an optical power meter 8.

Modern measurement techniques for the polarization dependent loss are often based of the Mueller method. For performing a PDL measurement according to the Mueller method, the polarization state of the polarized light 4 is consecutively set to four different orthogonal polarization states, and for each of said four polarization states, both a reference measurement (without DUT) and a DUT measurement are carried out. Therefore, eight measurements are required for determining the PDL of a device under test, whereby the power level of the DUT output signal 6 is determined either for a single wavelength or for a whole range of wavelengths. More details concerning the PDL-measurement according to the Mueller method can be found in the product note “PDL Measurements using the Agilent 8169A Polarization Controller” by Christian Hentschel and Sigmar Schmidt, which is herewith incorporated into the description of the present application, which can be accessed via the internet by the URL: http://advanced.comms.agilent.com/cm/rdmfg/oct/library/appnotes.shtml.

If the receiver circuit consisted only of a low-PDL optical power meter 8, then PDL measurements with high accuracy would be readily available. However, in most cases, the optical power meter 8 exhibits PDL and is preceded by other optical components such as couplers and switches. In FIG. 1, these components are represented by the output circuit 7. The optical components of the output circuit 7 exhibit polarization dependent loss, and the output circuit's PDL affects the measurements of the DUT's PDL. The PDL of the output circuit 7 is the reason why repeated measurements of the device's PDL yield strongly varying results. The situation is furthermore complicated by the fact that the various PDL components of the output circuit 7 are often connected with devices that exhibit polarization mode dispersion (PMD).

A similar problem exists for all kind of power level measurements, where the polarization dependent loss (PDL) of the receiver circuit causes additional measurement errors. For example, for measuring the insertion loss or the insertion gain of a device under test, the power ratio of the DUT output signal to the DUT input signal is determined. In case the output circuit comprises optical components such as couplers and switches that exhibit polarization dependent loss, then this polarization dependence of the receiver circuit affects the insertion loss or gain measurements.

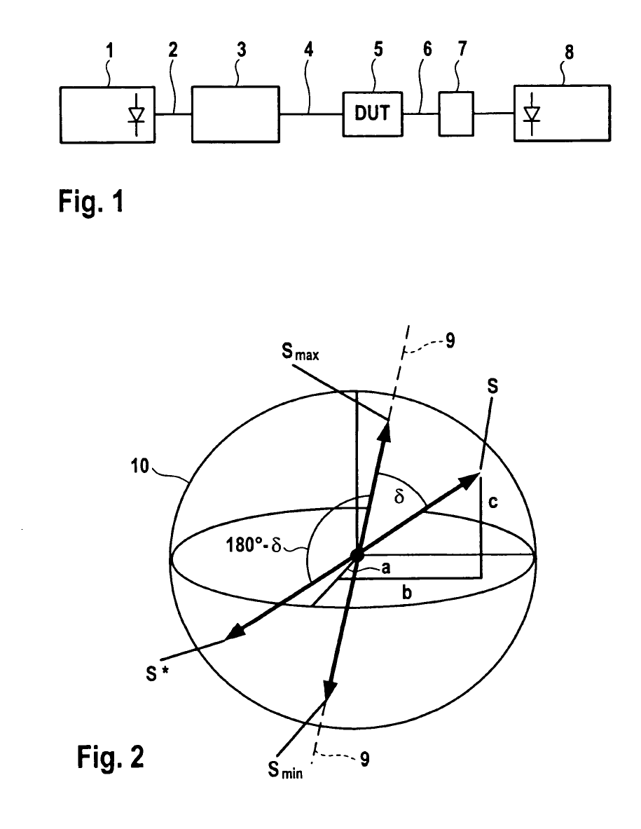

The PDL of the output circuit can be expressed by means of the output circuit's principal states of polarization. In FIG. 2, the Stokes vectors S_{max and S}ₘᵢₙ corresponding to the output circuit's principal states of polarization are shown in a Poincaré sphere representation. Sₘₐₓ denotes the polarization state where the transmission of the output circuit reaches its maximum, while Sₘᵢₙ is the polarization state corresponding to the output circuit's minimum transmission. These two polarization states are orthogonal to each other, which means that Sₘᵢₙ and Sₘₐₓ can be connected by a straight line that runs through the center of the Poincaré sphere 10. This straight line is the principal axis 9.

At the output of the device under test 5 in FIG. 1, a DUT output signal 6 with a polarization state S is obtained. The polarization state S can be represented by a vector (1, a, b, c) on the Poincaré sphere 10. Sₘᵢₙ and Sₘₐₓ are the polarization states where the transmission of the output circuit 7 assumes its minimum or maximum. As can be seen from FIG. 2, the angle between the principal state of maximum transmission Sₘₐₓ of the output circuit and the polarization state S is denoted as δ. If the polarization state S of the DUT output signal coincides with the principal state Sₘₐₓ, the angle δ becomes equal to zero, and the signal strength measured by the optical power meter will be larger than the correct value. In case S coincides with Sₘᵢₙ, δ will be equal to 180°, and the power level determined by the optical power meter will be smaller than the correct value. The power measurement error E_{PDL} due to the receiver circuit's PDL for a certain polarization state S can be expressed in terms of the angle δ:
E_{PDL}(S)=ΔA·cos δ (1)
whereby ΔA is the maximum change of transmission due to the PDL of the output circuit. When inserting δ=0° and δ=180° into the above equation, it becomes obvious that 2·ΔA is equal to the output circuit's PDL.

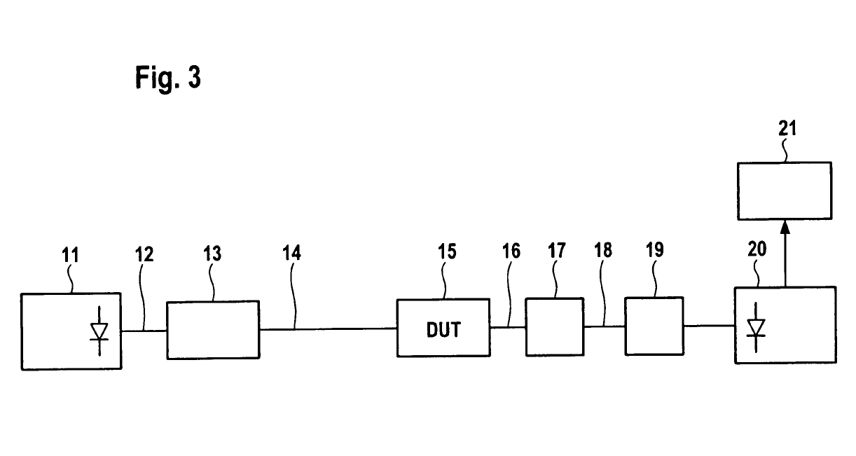

In FIG. 3, a measurement set-up for determining the polarization dependent loss of a device under test is shown, which has been modified according to the inventive concept. The invention can be applied to any optical measurement in which a polarization dependent error is superimposed on the optical property that has to be determined. The set-up of FIG. 3 comprises a laser source 11, which can either be a tunable or a fixed laser source, which emits a ray of light 12. The polarization state of the light 12 is set by a polarization controller 13, and the polarized light 14 obtained at the output of the polarization controller 13 is incident upon a device under test 15. The DUT output signal 16 is forwarded to a polarization conversion unit 17, which transforms the polarization state of the DUT output signal 16 consecutively into a set of n different polarization states. At the output of the polarization conversion unit 17, n derived optical signals 18 are obtained. The derived optical signals 18 are forwarded, via the output circuit 19, to the optical power meter 20, and there, the signal strength is determined for each of said n derived optical signals 18. Each of the n measurement results obtained on the part of the optical power meter 20 is degraded by a corresponding polarization dependent error E_{PDL}(i). The n power measurement results obtained for the n derived optical signals are forwarded to an averaging unit 21 and in the averaging unit 21, the average power P_{AVERAGE} of the n optical powers Pᵢ, i=1, . . . ,n is determined. Preferably, the arithmetic mean value of said n power measurement results is determined. It should be noted that instead of generating the derived optical signals 18 consecutively, the derived optical signals can also be generated in parallel.

Each of the n power measurements is impaired by a corresponding measurement error E_{PDL}(i). With the above formula (1), the total measurement error E_{AVERAGE} of the averaged power P_{AVERAGE} can be written as

$${E}_{AVERAGE} = \frac{1}{n} \cdot {\sum }_{i = 1}^{n} {E}_{PDL} ( i ) = \frac{1}{n} \cdot Δ A \cdot {\sum }_{i = 1}^{n} cos {δ}_{i} \qquad ( 2 )$$

whereby E_{PDL}(i) denotes the respective error of the power measurement for Pᵢ. The idea is to choose the polarization states i, i=1, . . . n of the derived optical signals in a way that

$${\sum }_{i = 1}^{n} cos {δ}_{i} \approx 0.$$

By doing this, the total error E_{AVERAGE} can be minimized, and the polarization dependent error of the average power will be much smaller than the polarization dependent error of each single power measurement.

The measurement set-up shown in FIG. 3 can not only be used for determining the polarization dependent loss of a device under test 15, but also for determining the insertion loss or gain of a device under test 15. Also in this case, the accuracy can be substantially improved by including a polarization conversion unit into the signal path, and by averaging over a set of different well-defined polarization states. For the measurement of the insertion loss or gain, the polarization controller 13 can be used to set the polarization state of the light incident upon the DUT consecutively to a set of different polarization states, whereby the polarization conversion unit 17, the output circuit 19, the optical power meter 20, and the averaging unit 21 ensure correct measurements of the DUT output signal. The obtained averaged insertion loss or gain does no longer depend on the polarization state of the incident light.

According to a first embodiment of the invention, a polarization conversion unit, for example the polarization conversion unit 17, generates two well-defined polarization states from the incident light's polarization state S, whereby the first one of said two polarization states is the incident light's polarization state S itself, and whereby the second one of said two polarization states is the inverse S* of the incident lights polarization state S. In FIG. 2, the polarization state S of the incident light is shown together with the inverse polarization state S*. The inverted polarization state S* is obtained from the state S=(1, a, b, c) by changing the sign of the Stokes vector components a, b, c, in order to obtain S*=(1, −a, −b, −c). The polarization states S and S* are orthogonal to each other, and therefore, they can be connected by a straight line through the center of the Poincaré sphere. When δ denotes the angle between S and Sₘₐₓ, the angle between the inverted polarization state S* and the principal state Sₘₐₓ of highest transmission is (180°−δ).

For the two states S and S*, the respective measurement error E_{PDL} caused by the PDL of the receiver circuit can be expressed as follows:
E_{PDL}(S)=ΔA·cos δ;
E_{PDL}(S*)=ΔA·cos(180°−δ)=−ΔA·cos δ (3)

When determining the average power P_{AVERAGE} of the powers obtained for S and S*, any polarization dependent error of P_{AVERAGE} is eliminated, because the measurement errors E_{PDL}(S) and E_{PDL}(S*) cancel each other:

$${E}_{AVERAGE} = \frac{1}{2} ( {E}_{PDL} ( S ) + {E}_{PDL} ( {S}^{*} ) ) = \frac{Δ A}{2} ( cos δ + cos ( {180}^{°} - δ ) ) = 0 \qquad ( 4 )$$

In the following, a second and a third embodiment of the invention will be described. According to these embodiments, the incident light's polarization state is converted into four different polarization states S_{A}, S_{B}, S_{C}, and S_{D}. These four polarization states are consecutively generated by the polarization conversion unit, and the signal strength is measured individually for each of these polarization states. Then, an averaging procedure is performed with respect to the obtained power values.

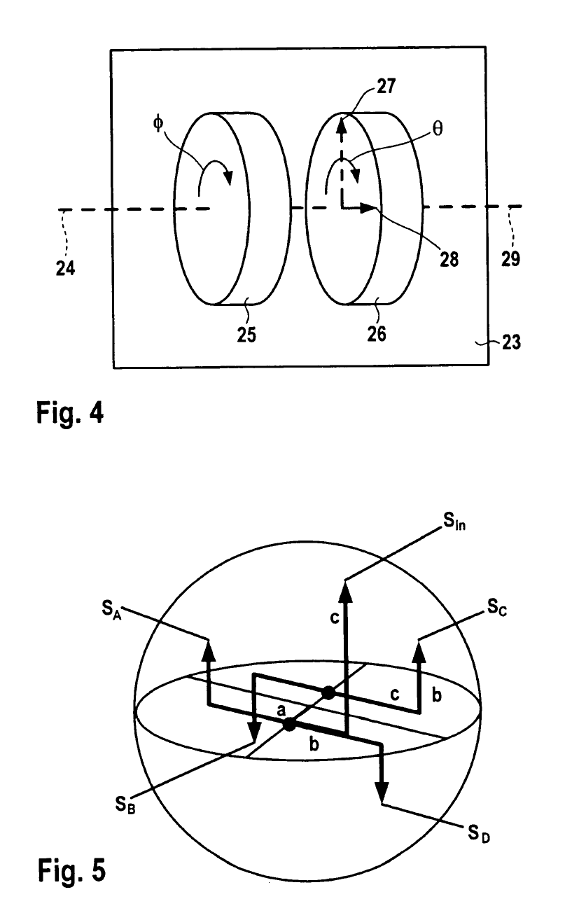

According to the second embodiment of the invention, the set of four different well-defined polarization states is generated by means of a planar rotator and a rotatable quarter wave plate. In FIG. 4, a polarization conversion unit 23 according to the second embodiment of the invention is shown. The DUT output signal 24 is incident upon a planar rotator 25, followed by a rotatable quarter wave plate 26 having a slow axis 27 and a fast axis 28. The polarization state of the DUT output signal 24 can be converted into any one of the desired polarization states S_{A}, S_{B}, S_{C}, S_{D}, and at the output of the polarization conversion unit 23, derived optical signals 29 with the respective polarization states are obtained.

A planar rotator will rotate any linear input state by a predefined angle φ. When the polarization state is rotated by an angle φ, this corresponds to a rotation of the corresponding Stokes vector by 2φ on the Poincaré equator in a Poincaré sphere representation. The Mueller matrix M(rotator, φ) for a physical rotation of the planar rotators input polarization state by an angle φ can be written as:

$$M ( rotator , ϕ ) = ( \begin{matrix}1 & 0 & 0 & 0 \\ 0 & cos 2 ϕ & sin 2 ϕ & 0 \\ 0 & - sin 2 ϕ & cos 2 ϕ & 0 \\ 0 & 0 & 0 & 1\end{matrix} ) \qquad ( 5 )$$

For the polarization conversion unit 23 shown in FIG. 4, it is necessary to vary the planar rotator's angle of rotation φ. Preferably, a Faraday rotator is used, in which the angle of rotation φ is controlled by the magnitude of a magnetic field in the direction of light propagation. A Faraday rotator consists of an optically active material, such as quartz or yttrium-iron-garnet. By varying the magnitude of the magnetic field, the angle of rotation φ can be set to any desired value, whereby the angular orientation of the planar rotator 25 itself is not relevant. The rotator itself is not rotated.

A DUT output signal 24 with a polarization state (1, a, b, c) is input to the polarization conversion unit 23. If the angle of rotation of the planar rotator 25 is set to φ=0°, the planar rotator 25 will not change the state of polarization. If the angle of rotation of the planar rotator 25 is set to φ=90°, a signal with the polarization state (1, −a, −b, c) will be obtained at the rotator's output.

This polarization state will be further modified by the rotatable quarter wave plate 26. The quarter wave plate used in the second embodiment of the invention can be rotated by an angle θ about a rotation axis which is identical with the center of the beam. When θ=0°, the slow axis 27 and the fast axis 28 of the quarter wave plate are oriented as shown in FIG. 4. In this case, the behavior of the quarter wave plate can be described by the Mueller matrix

$$M ( QWP , θ = {0}^{°} ) = ( \begin{matrix}1 & 0 & 0 & 0 \\ 0 & 1 & 0 & 0 \\ 0 & 0 & 0 & - 1 \\ 0 & 0 & 1 & 0\end{matrix} ) \qquad ( 6 )$$

The quarter wave plate with θ=0° will convert a Stokes vector (1, a, b, c) into a Stokes vector (1, a, −c, b). In case the quarter wave plate is rotated by an angle θ=90°, the slow axis 27 and the fast axis 28 in FIG. 4 are swapped. In this case, the behavior of the quarter wave plate can be expressed by the following Mueller matrix:

$$M ( QWP , θ = {90}^{°} ) = ( \begin{matrix}1 & 0 & 0 & 0 \\ 0 & 1 & 0 & 0 \\ 0 & 0 & 0 & 1 \\ 0 & 0 & - 1 & 0\end{matrix} ) \qquad ( 7 )$$

A Stokes vector (1, a, b, c) will be converted into a Stokes vector (1, a, c, −b).

In the following, it will be described how the four polarization states S_{A}, S_{B}, S_{C}, S_{D} can be generated by means of the planar rotator and the rotatable quarter wave plate from incident light with a polarization state Sᵢₙ=(1, a, b, c). Initially, the rotation angle of the planar rotator 25 is set to φ=0°, and the rotatable quarter wave plate is rotated by θ=0°. The resulting polarization state can be obtained by multiplying Sᵢₙ with the Mueller matrix M(QWP, 0°), and the state of polarization S_{A}=(1, a, −c, b) is obtained.

In FIG. 5, both the initial state of polarization Sᵢₙ and the derived polarization states S_{A}, S_{B}, S_{C}, S_{D} are shown in a Poincaré sphere representation. For the state of polarization S_{A}, the corresponding optical power level P_{A} is measured. In case a tunable laser source is used for determining wavelength dependent PDL values, a wavelength sweep covering a whole range of wavelengths is carried out, and P_{A} is measured as a function of wavelength. Alternatively, a fixed laser source suitable for single wavelength operation can be used.

Next, the polarization state S_{B} is generated by setting the rotation angle of the planar rotator to φ=90°. This can be done by activating the magnetic field of a Faraday rotator. The position of a quarter wave plate is kept at θ=0°. The rotator transforms the polarization state Sᵢₙ into the intermediate polarization state (1, −a, −b, c). At the output of the quarter wave plate, the polarization state SB=(1, −a, −c, −b) is obtained, and the optical power P_{B} is measured. Then, the polarization state S_{C} is produced. The rotation angle of the planar rotator is maintained at φ=90°, and the quarter wave plate is rotated by an angle of θ=90°. The rotator converts the input polarization state Sᵢₙ into the intermediate state (1, −a, −b, c), and the quarter wave plate transforms this state into the polarization state S_{C}=(1, −a, c, b). The corresponding optical power P_{C} of the DUT output signal is measured. Next, the polarization conversion unit will convert the input polarization state Sᵢₙ into the polarization state S_{D} by setting the rotation angle φ of the planar rotator to φ=0°, whereby the quarter wave plate remains in its rotated position at θ=90°. For the obtained polarization state S_{D}=(1, a, c, −b), the power measurement is repeated, and the corresponding optical power P_{D} is recorded.

Now, the complete set of optical powers P_{A}, P_{B}, P_{C}, P_{D} required for the averaging procedure is available. Of course, the four polarization states S_{A}, S_{B}, S_{C}, S_{D} can also be generated in an order that differs from the order described above. The average power P_{AVERAGE} is obtained as the arithmetic means of the optical powers determined for the set of derived polarization states:

$${P}_{AVERAGE} = \frac{{P}_{A} + {P}_{B} + {P}_{C} + {P}_{D}}{4} \qquad ( 8 )$$

In FIG. 5, the four output states S_{A}, S_{B}, S_{C}, S_{D} are shown for an arbitrary input state Sᵢₙ. It can be mathematically shown that the polarization dependent measurement errors of the four power measurements cancel to zero after the four power results have been summed up, and that the total polarization dependent measurement error of P_{AVERAGE} is substantially zero. In summary, the depolarizer works perfectly for all input polarization states, no matter whether the input polarization state is a linear polarization state or an elliptical polarization state.

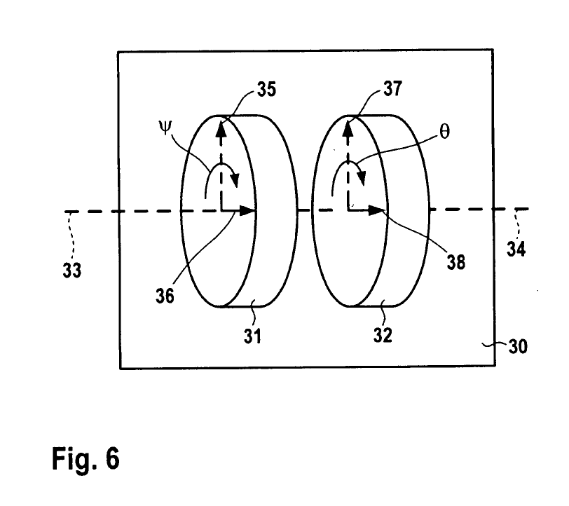

In the following, a third embodiment of the invention will be described. According to this embodiment, a rotatable half wave plate is used instead of the planar rotator employed in the second embodiment. As depicted in FIG. 6, the polarization conversion unit 30 comprises a rotatable half wave plate 31 and a rotatable quarter wave plate 32. The polarization conversion unit 30 transforms the DUT output signal 33 into a set of derived optical signals 34 with different well-defined polarization states. The rotation angle of the half wave plate 31 is denoted as ψ, while the rotation angle of the quarter wave plate 32 is again denoted as θ (as in the second embodiment). For the case of ψ=0°, the orientation of the slow axis 35 and the fast axis 36 of the half wave plate 31 is shown in FIG. 6. The orientation of the quarter wave plate with its slow axis 37 and its fast axis 38 is shown for the case θ=0°. In case of ψ=0°, an input state Sᵢₙ=(1, a, b, c) is converted into a polarization state (1, a, −b, −c). This behavior of the half wave plate for ψ=0° can be summarized by the corresponding Mueller matrix

$$M ( HWP , ψ = {0}^{°} ) = ( \begin{matrix}1 & 0 & 0 & 0 \\ 0 & 1 & 0 & 0 \\ 0 & 0 & - 1 & 0 \\ 0 & 0 & 0 & - 1\end{matrix} ) \qquad ( 10 )$$

When the half wave plate is rotated by 45° (ψ=45°), the half wave plate converts an input state Sᵢₙ=(1, a, b, c) into a polarization state (1, −a, b, −c), and this behavior can be expressed by the following Mueller matrix:

$$M ( HWP , ψ = {45}^{°} ) = ( \begin{matrix}1 & 0 & 0 & 0 \\ 0 & - 1 & 0 & 0 \\ 0 & 0 & 1 & 0 \\ 0 & 0 & 0 & - 1\end{matrix} ) \qquad ( 11 )$$

In the following, it will be explained how the rotatable half wave plate 31 and the rotatable quarter wave plate 32 shown in FIG. 6 can be used for converting an arbitrary input state Sᵢₙ=(1, a, b, c) into the four polarization states S_{D}, S_{C}, S_{B}, S_{A} shown in FIG. 5. For generating the first one of said four polarization states, the rotation angle of the half wave plate is set to ψ=0°, and the rotation angle of the quarter wave plate is set to θ=0°. At the output at the half wave plate 31, the intermediate state (1, a, −b, −c) is obtained, which is converted by the quarter wave plate 32 into the state (1, a, c, −b), which is the polarization state S_{D}. Thus, the setting ψ=0°, θ=0° generates the output state S_{D}=(1, a, c, −b) at the output of the polarization conversion unit 30. For this polarization state S_{D}, the corresponding optical power P_{D} is determined.

Next, the rotation angle of the half wave plate 31 is set to ψ=45°, and the rotation angle of the quarter wave plate 32 remains at θ=0°. At the output of the half wave plate, the intermediate state (1, −a, b, −c) is obtained, and at the output of the quarter wave plate, the polarization state (1, −a, c, b) is generated, which is the polarization state S_{C} shown in FIG. 5. The corresponding optical power P_{C} is measured. Then, the rotation angle of the half wave plate is kept at ψ=45°, while the quarter wave plate is rotated to the angular position θ=90°. Now, the intermediate polarization state is (1, −a, b, −c), and the polarization state at the output of the polarization conversion unit is S_{B}=(1, −a, −c, −b). Again, the corresponding optical power P_{B} is determined. The last one of the four polarization states is generated by setting the rotation angle ψ of the half wave plate to ψ=0°, and by keeping the rotation angle of the quarter wave plate at θ=90°. At the output of the half wave plate, the intermediate polarization state (1, a, −b, −c) is obtained, which is transformed by the quarter wave plate into the polarization state S_{A}=(1, a, −c, b). Also for this polarization state, the optical power P_{A} is measured.

As soon as the corresponding optical powers P_{A}, P_{B}, P_{C}, P_{D} are known, the average optical power P_{AVERAGE} can be determined by means of the above formula (8). It does not matter in which order the four polarization states S_{A}, S_{B}, S_{C}, S_{D} are generated.

1. A polarization conversion unit adapted for receiving from an optical circuit a first optical signal with a first polarization state, and for generating, from said first optical signal, a set of n derived optical signals with n different well-defined polarization states i, i=1, . . . , n, with n being a natural number greater than one, wherein said n different well-defined polarization states are selected such that the sum of the cosines of δ over the n polarization states i, i=1, . . . , n, with δ denoting the angle between the respective polarization state i and the polarization state of maximum transmission of the optical circuit in a Poincaré sphere representation, is substantially equal to zero.

2-4. (canceled)

5. The polarization conversion unit according to claim 1, wherein, from said first polarization state, two derived optical signals with two different polarization states are generated, whereby the second one of said two polarization states is the inverse of the first one of said two polarization states.

6. The polarization conversion unit according to claim 1, wherein, from said first polarization state, which can be represented by a Stokes vector with the coordinates 1, a, b, c in a Poincaré sphere representation, four derived optical signals with four different polarization states are generated, whereby said four polarization states can be represented by Stokes vectors with each the coordinates 1, a, −c, b; 1, −a, −c, −b; 1, −a, c, b; and 1, a, c, −b in a Poincaré sphere representation.

7. The polarization conversion unit according to claim 1, comprising a planar rotator, preferably a Faraday rotator, preferably based on an optically active material, and a rotatable quarter wave plate for generating said n derived optical signals.

8. The polarization conversion unit according to claim 7, wherein
said planar rotator is set to a rotation angle of 0° and said quarter wave plate is rotated by 0° in order to generate a first derived optical signal corresponding to a Stokes vector 1, a, −c, b;
said planar rotator is set to a rotation angle of 90° and said quarter wave plate is rotated by 0° in order to generate a second derived optical signal corresponding to a Stokes vector 1, −a, −c, −b;
said planar rotator is set to a rotation angle of 90° and said quarter wave plate is rotated by 90° in order to generate a third derived optical signal corresponding to a Stokes vector 1, −a, c, b;
said planar rotator is set to a rotation angle of 0° and said quarter wave plate is rotated by 90° in order to generate a fourth derived optical signal corresponding to a Stokes vector 1, a, c, −b in a Poincaré sphere representation,
whereby said four derived optical signals are generated in arbitrary order.

9. The polarization conversion unit according to claim 1, comprising a rotatable half wave plates and a rotatable quarter wave plate for generating said n derived optical signals.

10. The polarization conversion unit according to claim 9, wherein
said half wave plate is rotated by 0° and said quarter wave plate is rotated by 0° in order to generate a first derived optical signal corresponding to a Stokes vector 1, a, c, −b;
said half wave plate is rotated by 45° and said quarter wave plate is rotated by 0° in order to generate a second derived optical signal corresponding to a Stokes vector 1, −a, c, b;
said half wave plate is rotated by 45° and said quarter wave plate is rotated by 90° in order to generate a third derived optical signal corresponding to a Stokes vector 1, −a, −c, −b;
said half wave plate is rotated by 0° and said quarter wave plate is rotated by 90° in order to generate a fourth derived optical signal corresponding to a Stokes vector 1, a, −c, b in a Poincaré sphere representation,
whereby said four derived optical signals are generated in arbitrary order.

11. An optical measurement system for determining a signal strength of a first optical signal with a first polarization state, comprising
a polarization conversion unit according to claim 1;
a determination unit adapted for measuring the signal strengths of the n derived optical signals generated by said polarization conversion unit;
an averaging unit which determines an average value of the signal strengths for the n derived optical signals.

12. (canceled)

13. A measurement set-up for determining an insertion loss of a device under test—DUT—comprising:
a light source, in particular a tunable light source, adapted for generating light that is incident on said DUT;
said DUT which generates, in response to said incident light, a response signal; and
a polarization conversion unit according to claim 1, which derives, from at least one of: said incident light or said response signal, a set of n derived optical signals with n different well-defined polarization states,
a determination unit adapted for measuring the signal strengths of the n derived optical signals generated by said polarization conversion unit;
an averaging unit which averages the measurement results obtained for the n derived well-defined polarization states.

14. The measurement set-up according to claim 13, further comprising a polarization controller for converting the light of said light source to a number of polarization states at the input of the DUT.

15. A measurement set-up for determining a polarization dependent loss of a device under test—DUT—comprising:
a light source, in particular a tunable light source;
a polarization controller adapted for varying the polarization state of the light emitted by said light source, in order to generate polarized light that is incident on said DUT;
said DUT which generates, in response to said polarized light, a response signal; and
a polarization conversion unit according to claim 1, which derives, from at least one of: said incident light or said response signal, a set of n derived optical signals with n different well-defined polarization states,
a determination unit adapted for measuring the signal strengths of the n derived optical signals generated by said polarization conversion unit;
an averaging unit which averages the measurement results obtained for the n derived well-defined polarization states.

16. A method for reducing or eliminating polarization dependent measurement errors, said method comprising the steps of:
receiving a first optical signal from an optical circuit,
generating from the first optical signal a set of n derived optical signals with n different well-defined polarization states, whereby said n different well-defined polarization states are selected such that the sum of the cosines of δ over the n polarization states i, i=1, . . . , n, with δ denoting the angle between the respective polarization state i and the polarization state of maximum transmission of the optical circuit in a Poincaré sphere representation, is substantially equal to zero.

17-24. (canceled)

25. A software program or product, stored on a data carrier, for controlling the steps of:
receiving a first optical signal from an optical circuit,
generating from the first optical signal a set of n derived optical signals with n different well-defined polarization states, whereby said n different well-defined polarization states are selected such that the sum of the cosines of δ over the n polarization states i, i=1, . . . , n, with δ denoting the anile between the respective polarization state i and the polarization state of maximum transmission of the optical circuit in a Poincaré sphere representation, is substantially equal to zero, when run on a data processing system such as a computer.

26. (canceled)
